(19) United States
(12) Patent Application Publication
(10) Pub. No.: US 2017/0090609 A1
(43) Pub. Date: Mar. 30, 2017

(54) OVERSAMPLED STEP AND WAIT SYSTEM FOR CAPACITIVE SENSING

(71) Applicant: SYNAPTICS INCORPORATED, San Jose, CA (US)

(72) Inventors: Vladan PETROVIC, San Jose, CA (US); David SOBEL, Los Altos, CA (US)

(21) Appl. No.: 14/866,142

(22) Filed: Sep. 25, 2015

(51) Int. Cl. G06F 3/044; G06F 3/041

(52) U.S. Cl. CPC G06F 3/044; G06F 3/0416

(57) ABSTRACT

Embodiments described herein include a method, input device, and processing system for capacitive sensing. The input device comprises a plurality of transmitter electrodes and a plurality of receiver electrodes. The method comprises transmitting, on one or more of the plurality of transmitter electrodes, a capacitive sensing signal comprising a plurality of sensing half-cycles. The method further comprises sampling, two or more times during each sensing half-cycle, effects of the transmitted capacitive sensing signal on one or more of the plurality of receiver electrodes to produce half-cycle sensing data, filtering the half-cycle sensing data, and determining positional information for an input object using the filtered half-cycle sensing data.

### BACKGROUND

Field of the Disclosure

Embodiments of the present disclosure generally relate to managing interference susceptibility of capacitive sensing systems, and more specifically, to reducing susceptibility through oversampling the effects of a transmitted capacitive sensing signal and filtering the oversampled effects.

Description of the Related Art

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

One embodiment described herein is a method of capacitive sensing using an input device comprising a plurality of transmitter electrodes and a plurality of receiver electrodes. The method comprises transmitting, on one or more of the plurality of transmitter electrodes, a capacitive sensing signal comprising a plurality of sensing half-cycles. The method further comprises sampling, two or more times during each sensing half-cycle, effects of the transmitted capacitive sensing signal on one or more of the plurality of receiver electrodes to produce half-cycle sensing data, filtering the half-cycle sensing data, and determining positional information for an input object using the filtered half-cycle sensing data.

Another embodiment described herein is an input device comprising a plurality of transmitter electrodes, a plurality of receiver electrodes; and a processing system coupled with the plurality of transmitter electrodes and the plurality of receiver electrodes. The processing system comprises circuitry configured to transmit, on one or more of the plurality of transmitter electrodes, a capacitive sensing signal comprising a plurality of sensing half-cycles. The processing system circuitry is further configured to sample, two or more times during each sensing half-cycle, effects of the transmitted capacitive sensing signal on one or more of the plurality of receiver electrodes to produce half-cycle sensing data, filter the half-cycle sensing data, and determine positional information for an input object using the filtered half-cycle sensing data.

Another embodiment described herein is a processing system for capacitive sensing, comprising touch controller circuitry configured to couple with a plurality of transmitter electrodes and a plurality of receiver electrodes, and transmit, on one or more of the plurality of transmitter electrodes, a capacitive sensing signal comprising a plurality of sensing half-cycles. The touch controller circuitry is further configured to sample, two or more times during each sensing half-cycle, effects of the transmitted capacitive sensing signal on one or more of the plurality of receiver electrodes to produce half-cycle sensing data, filter the half-cycle sensing data, and determine positional information for an input object using the filtered half-cycle sensing data.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram of an input device integrated into an exemplary display device, according to one embodiment.

FIG. 2 is a block diagram of an exemplary processing system, according to one embodiment.

FIGS. 3A and 3B are block diagrams illustrating different implementations of an exemplary filter module, according to one embodiment.

FIG. 4 is a timing diagram illustrating operation of an exemplary processing system, according to one embodiment.

FIG. 5A illustrates impulse responses of components of an exemplary filter module, according to one embodiment.

FIG. 5B illustrates frequency response of components of an exemplary filter module, according to one embodiment.

FIGS. 6A and 6B illustrate effects of a reset switch within a charge integrator module, according to one embodiment.

FIG. 6C illustrates an exemplary reset correction module, according to one embodiment.

FIG. 7 illustrates a method of capacitive sensing, according to one embodiment.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

The following detailed description is merely exemplary in nature and is not intended to limit the disclosure or the application and uses of the disclosure. Furthermore, there is no intention to be bound by any expressed or implied theory presented in the preceding technical field, background, brief summary, or the following detailed description.

Various embodiments of the present technology provide input devices and methods for improving usability. An input device may include sensor electrodes that are used as sensing elements to detect interaction between the input device and an input object (e.g., a stylus or a user's finger). To do so, the input device may drive a capacitive sensing signal onto the sensor electrodes. In some cases, the capacitive sensing signal includes a plurality of sensing half-cycles having alternating polarity. Based on measuring capacitances associated with driving the capacitive sensing signal, the input device determines a location of user interaction with the input device. In some embodiments, the sensor electrodes can be susceptible to interference from other emitters located proximate to the sensor electrodes. The other emitters may be included in the input device, such as one or more display electrodes of a display screen associated with the input device, or may be external to the input device.

According to several embodiments described herein, to improve immunity to interference, the processing system of the input device may acquire multiple samples during each sensing half-cycle and perform filtering functions on the resulting data to shape the interference spectrum. For example, a digital windowing filter may operate to perform weighted averaging of the data and may thereby reduce the susceptibility of the input device. Sampling may occur during an integration period within each sensing half-cycle, and a stretch period during each sensing half-cycle operates to pause the integration and/or to reset the integration count to a predetermined value. However, the reset functionality may introduce frequency susceptibility to the input device, reducing or negating the beneficial effects of oversampling and filtering. Therefore, in some embodiments, a reset correction module is applied to mitigate the effects of the reset and restore the reduced immunity due to oversampling and filtering.

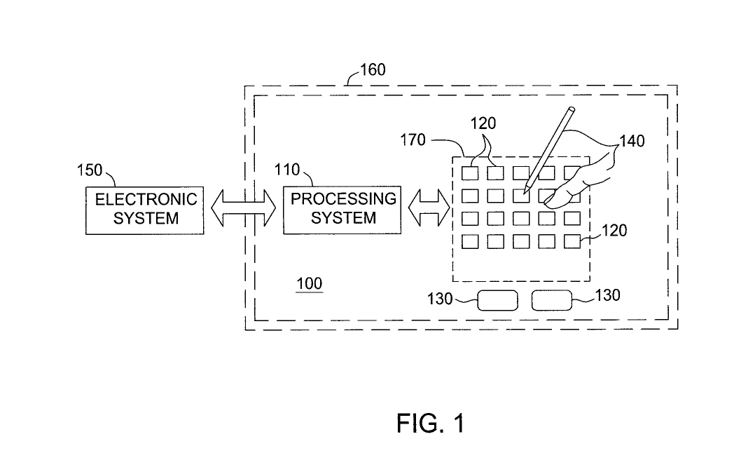

FIG. 1 is a schematic block diagram of an input device 100 integrated into an exemplary display device 160, in accordance with embodiments of the present technology. Although the illustrated embodiments of the present disclosure are shown integrated with a display device, it is contemplated that the disclosure may be embodied in input devices that are not integrated with display devices. The input device 100 may be configured to provide input to an electronic system 150. As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 170. Example input objects include fingers and styli, as shown in FIG. 1.

Sensing region 170 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 170 extends from a surface of the input device 100 in one or more directions into space until signal-to-noise ratios prevent sufficiently accurate object detection. The distance to which this sensing region 170 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 170 has a rectangular shape when projected onto an input surface of the input device 100.

The input device 100 may utilize any combination of sensor components and sensing technologies to detect user input in the sensing region 170. The input device 100 comprises a plurality of sensing 120 for detecting user input. The input device 100 may include one or more sensing elements 120 that are combined to form sensor electrodes. As several non-limiting examples, the input device 100 may use capacitive, elastive, resistive, inductive, magnetic acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements 120 pickup loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements 120 to create electric fields. In some capacitive implementations, separate sensing elements 120 may be ohmically shorted together to form larger sensor electrodes. Some capacitive implementations utilize resistive sheets, which may be uniformly resistive.

As discussed above, some capacitive implementations utilize “self capacitance” (or “absolute capacitance”) sensing methods based on changes in the capacitive coupling between sensor electrodes 120 and an input object. In one embodiment, processing system 110 is configured to drive a voltage with known amplitude onto the sensor electrode 120 and measure the amount of charge required to charge the sensor electrode to the driven voltage. In other embodiments, processing system 110 is configured to drive a known current and measure the resulting voltage. In various embodiments, an input object near the sensor electrodes 120 alters the electric field near the sensor electrodes 120, thus changing the measured capacitive coupling. In one implementation, an absolute capacitance sensing method operates by modulating sensor electrodes 120 with respect to a reference voltage (e.g. system ground) using a modulated signal, and by detecting the capacitive coupling between the sensor electrodes 120 and input objects 140.

Additionally as discussed above, some capacitive implementations utilize “mutual capacitance” (or “transcapacitance”) sensing methods based on changes in the capacitive coupling between sensing electrodes. In various embodiments, an input object 140 near the sensing electrodes alters the electric field between the sensing electrodes, thus changing the measured capacitive coupling. In one implementation, a transcapacitive sensing method operates by detecting the capacitive coupling between one or more transmitter sensing electrodes (also “transmitter electrodes”) and one or more receiver sensing electrodes (also “receiver electrodes”) as further described below. Transmitter sensing electrodes may be modulated relative to a reference voltage (e.g., system ground) to transmit a transmitter signals. Receiver sensing electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensing electrodes may be dedicated transmitter electrodes or receiver electrodes, or may be configured to both transmit and receive.

In FIG. 1, the processing system 110 is shown as part of the input device 100. The processing system 110 is configured to operate the hardware of the input device 100 to detect input in the sensing region 170. The processing system 110 comprises parts of or all of one or more integrated circuits (ICs) and/or other circuitry components. (For example, a processing system for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) 120 of the input device 100. In other embodiments, components of processing system 110 are physically separate with one or more components close to sensing element(s) 120 of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing elements 120 to detect input, identification modules configured to identify gestures such as mode changing gestures, and mode changing modules for changing operation modes. Processing system 110 may also comprise one or more controllers.

In some embodiments, the processing system 110 responds to user input (or lack of user input) in the sensing region 170 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) 120 of the input device 100 to produce electrical signals indicative of input (or lack of input) in the sensing region 170. The processing system 110 may perform any appropriate amount of processing on the electrical signals in producing the information provided to the electronic system. For example, the processing system 110 may digitize analog electrical signals obtained from the sensing elements 120. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 170, or some other functionality. FIG. 1 shows buttons 130 near the sensing region 170 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 170 overlaps at least part of an active area of a display screen of the display device 160. For example, the input device 100 may comprise substantially transparent sensing elements 120 overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display device 160 may share physical elements. For example, some embodiments may utilize some of the same electrical components for displaying and sensing. As another example, the display device 160 may be operated in part or in total by the processing system 110.

It should be understood that while many embodiments of the present technology are described in the context of a fully functioning apparatus, the mechanisms of the present technology are capable of being distributed as a program product (e.g., software) in a variety of forms. For example, the mechanisms of the present technology may be implemented and distributed as a software program on information bearing media that are readable by electronic processors (e.g., non-transitory computer-readable and/or recordable/writable information bearing media readable by the processing system 110). Additionally, the embodiments of the present technology apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

### Sensor Electrode Arrangements

In one embodiment, the sensor electrodes 120 may be arranged on different sides of the same substrate. For example, each of the sensor electrode(s) 120 may extend longitudinally across one of the surfaces of the substrate. Further still, on one side of the substrate, the sensor electrodes 120 may extend in a first direction, but on the other side of the substrate, the sensor electrodes 120 may extend in a second direction that is either parallel with, or perpendicular to, the first direction. For example, the sensor electrodes 120 may be shaped as bars or stripes where the sensor electrodes 120 on one side of the substrate extend in a direction perpendicular to the sensor electrodes 120 on the opposite side of the substrate.

The sensor electrodes 120 may be formed into any desired shape on the sides of the substrate. Moreover, the size and/or shape of the sensor electrodes 120 on one side of the substrate may be different than the size and/or shape of the sensor electrodes 120 on another side of the substrate. Additionally, the sensor electrodes 120 on a same side may have different shapes and/or sizes.

In another embodiment, the sensor electrodes 120 may be formed on different substrates that are then laminated together. In one example, a first plurality of the sensor electrodes 120 disposed on one of the substrate may be used to transmit a sensing signal (i.e., transmitter electrodes) while a second plurality of the sensor electrodes 120 disposed on the other substrate are used to receive resulting signals (i.e., receiver electrodes). In other embodiments, the first and/or second plurality of sensor electrodes 120 may be driven as absolute capacitive sensor electrodes. In one embodiment, the first plurality of sensor electrodes may be larger (larger surface area) than the second plurality of sensor electrodes, although this is not a requirement. In other embodiments, the first plurality and second plurality of sensor electrodes may have a similar size and/or shape. Thus, the size and/or shape of the sensor electrodes 120 on one of the substrates may be different than the size and/or shape of the electrodes 120 on the other substrate. Nonetheless, the sensor electrodes 120 may be formed into any desired shape on their respective substrates. Additionally, the sensor electrodes 120 on a same substrate may have different shapes and sizes.

In another embodiment, the sensor electrodes 120 are all located on the same side or surface of a common substrate. In one example, a first plurality of the sensor electrodes comprise jumpers in regions where the first plurality of sensor electrodes crossover the second plurality of sensor electrodes, where the jumpers are insulated from the second plurality of sensor electrodes. As above, the sensor electrodes 120 may each have the same size or shape or differing sizes and shapes.

In another embodiment, the sensor electrodes 120 are all located on the same side or surface of the common substrate are isolated from each other in the sensing region 170. In such embodiments, the sensor electrodes 120 are electrically isolated from each other. In one embodiment, the electrodes 120 are disposed in a matrix array where each sensor electrode 120 is substantially the same size and/or shape. In such embodiment, the sensor electrodes 120 may be referred to as a matrix sensor electrode. In one embodiment, one or more of sensor electrodes of the matrix array of sensor electrodes 120 may vary in at least one of size and shape. Each sensor electrode 120 of the matrix array may correspond to a pixel of the capacitive image. In one embodiment, the processing system 110 is configured to drive the sensor electrodes 120 with a modulated signal to determine changes in absolute capacitance. In other embodiment, processing system 110 is configured to drive a transmitter signal onto a first one of the sensor electrodes 120 and receive a resulting signal with a second one of the sensor electrodes 120. The transmitter signal(s) and modulated signal(s) may be similar in at least one of shape, amplitude, frequency, and phase. In various embodiments, the transmitter signal(s) and modulated signal(s) are the same signal. Further, the transmitter signal is a modulated signal that is used for transcapacitive sensing. In various embodiments, one or more grid electrodes may be disposed on the common substrate, between the sensor electrodes 120 where the grid electrode(s) may be used to shield and/or guard the sensor electrodes.

As used herein, “shielding” refers to driving a constant voltage onto an electrode, and “guarding” refers to driving a varying voltage signal onto a second electrode that is substantially similar in amplitude, frequency, and/or phase to the signal modulating the first electrode in order to measure the capacitance of the first electrode. Electrically floating an electrode can be interpreted as a form of guarding in cases where, by floating, the second electrode receives the desired guarding waveform via capacitive coupling from the first or a third electrode in the input device 100. In various embodiments, guarding may be considered to be a subset of shielding such that guarding a sensor electrode would also operate to shield that sensor electrode. The grid electrode may be driven with a varying voltage, a substantially constant voltage, or be electrically floated. The grid electrode may also be used as a transmitter electrode when it is driven with a transmitter signal such that the capacitive coupling between the grid electrode and one or more sensor electrodes may be determined. In one embodiment, a floating electrode may be disposed between the grid electrode and the sensor electrodes. In one particular embodiment, the floating electrode, the grid electrode, and the sensor electrode comprise the entirety of a common electrode of a display device. In other embodiments, the grid electrode may be disposed on a separate substrate or surface of a substrate than the sensor electrodes 120 or both. Although the sensor electrodes 120 may be electrically isolated on the substrate, the electrodes may be coupled together outside of the sensing region 170—e.g., in a connection region that transmits or receives capacitive sensing signals on the sensor electrodes 120. In various embodiments, the sensor electrodes 120 may be disposed in an array using various patterns where the electrodes 120 are not all the same size and shape. Furthermore, the distance between the electrodes 120 in the array may not be equidistant.

In any of the sensor electrode arrangements discussed above, the sensor electrodes 120 and/or grid electrode(s) may be formed on a substrate that is external to the display device 160. For example, the electrodes 120 and/or grid electrode(s) may be disposed on the outer surface of a lens in the input device 100. In other embodiments, the sensor electrodes 120 and/or grid electrode(s) are disposed between the color filter glass of the display device and the lens of the input device. In other embodiments, at least a portion of the sensor electrodes 120 and/or grid electrode(s) may be disposed such that they are between a Thin Film Transistor (TFT) substrate and the color filter glass of the display device 160. In one embodiment, a first plurality of sensor electrodes 120 and/or grid electrode(s) are disposed between the TFT substrate and color filter glass of the display device 160, and the second plurality of sensor electrodes 120 and/or a second grid electrode(s) are disposed between the color filter glass and the lens of the input device 100. In one embodiment, the second plurality of sensor electrodes 120 is disposed on one of the color filter glass, the lens, and a polarizer of the input device 100. In yet other embodiments, all of sensor electrodes 120 and/or grid electrode(s) are disposed between the TFT substrate and color filter glass of the display device, where the sensor electrodes 120 may be disposed on the same substrate or on different substrates as described above.

In one or more embodiment, at least a first plurality of the sensor electrodes 120 comprises one or more display electrodes of the display device 160 that are used in updating the display. For example, the sensor electrodes 120 may comprise the common electrodes such as one or more segments of a Vcom electrode, a source drive line, gate line, an anode sub-pixel electrode or cathode pixel electrode, or any other display element. These common electrodes may be disposed on an appropriate display screen substrate. For example, the common electrodes may be disposed on a transparent substrate (e.g., a glass substrate, TFT glass, or any other transparent material) in some display screens (e.g., In Plane Switching (IPS), Fringe Field Switching (FFS) or Plane to Line Switching (PLS), Organic Light Emitting Diode (OLED)), on the bottom of the color filter glass of some display screens (e.g., Patterned Vertical Alignment (PVA), Multi-domain Vertical Alignment (MVA), IPS, and FFS), over an cathode layer (e.g., OLED), etc. In such embodiments, the common electrode can also be referred to as a “combination electrode,” since it performs multiple functions. In various embodiments, each of the sensor electrodes 120 comprises one or more common electrodes associated with a pixel or sub pixel. In other embodiments, at least two sensor electrodes 120 may share at least one common electrode associated with a pixel or sub-pixel. While the first plurality of sensor electrodes may comprise one or more common electrodes configured for display updating and capacitive sensing, the second plurality of sensor electrodes may be configured for capacitive sensing and not for performing display updating. Further, in one or more embodiments, the grid electrode and/or floating electrode, when present, comprises one or more common electrodes.

Alternatively, all of the sensor electrodes 120 may be disposed between the TFT substrate and the color filter glass of the display device 160. In one embodiment, a first plurality of sensor electrodes are disposed on the TFT substrate, each comprising one or more common electrodes and a second plurality of sensor electrodes may be disposed between the color filter glass and the TFT substrate. Specifically, the receiver electrodes may be routed within the black mask on the color filter glass. In another embodiment, all of the sensor electrodes 120 comprise one or more common electrodes. The sensor electrodes 120 may be located entirely on the TFT substrate or the color filter glass as an array of electrodes. As discussed above, some of the sensor electrodes 120 may be coupled together in the array using jumper or all the electrodes 120 may be electrically isolated in the array and use grid electrodes to shield or guard the sensor electrodes 120. In one more embodiments, the grid electrode, when present, comprises one or more common electrodes.

In any of the sensor electrode arrangements described above, the sensor electrodes 120 may be operated in the input device 100 in a transcapacitance sensing mode by dividing the sensor electrodes 120 into transmitter and receiver electrodes, an absolute capacitance sensing mode, or some mixture of both. As will be discussed in more detail below, one or more of the sensor electrodes 120 or the display electrodes (e.g., source, gate, or reference (common) lines) may be used to perform shielding or guarding.

Continuing to refer to FIG. 1, the processing system 110 coupled with the sensor electrodes 120 includes a sensor module and in various embodiments, processing system 110 may additionally or alternatively comprise a display driver module (or “display module”). The sensor module includes circuitry configured to drive at least one of the sensor electrodes 120 for capacitive sensing during periods in which input sensing is desired. In one embodiment, the sensor module is configured to drive a modulated signal onto the at least one sensor electrode to detect changes in absolute capacitance between the at least one sensor electrode and an input object. In another embodiment, the sensor module is configured to drive a transmitter signal onto the at least one sensor electrode to detect changes in a transcapacitance between the at least one sensor electrode and another sensor electrode. The modulated and transmitter signals are generally varying voltage signals comprising a plurality of voltage transitions over a period of time allocated for input sensing and may also be referred to as a capacitive sensing signal. In various embodiments, the modulated signal and transmitter signal are similar in at least one shape, frequency, amplitude and/or phase. In other embodiments, the modulated signal and the transmitter signals are different in frequency, shape, phase, amplitude, and phase. The sensor module may be selectively coupled to one or more of the sensor electrodes 120. For example, the sensor module may be coupled to at least one of the sensor electrodes 120 and operate in absolute capacitance and/or transcapacitance sensing modes.

The sensor module includes circuitry configured to receive resulting signals with the sensor electrodes 120 comprising effects corresponding to the modulated signals or the transmitter signals during periods in which input sensing is desired. The sensor module may determine a position of the input object 140 in the sensing region 170 or may provide a signal including information indicative of the resulting signal to another module or processor, for example, a determination module or a processor of the electronic device (i.e., a host processor), for determining the position of the input object 140 in the sensing region 170.

The display driver module includes circuitry configured to provide display image update information to the display of the display device 160 during display updating periods. In one embodiment, the display driver is coupled to the display electrodes (source electrodes, gate electrodes, and Vcom electrodes) configured to drive at least one display electrode to set a voltage associated with a pixel of a display device, and to operate the at least one display electrode in a guard mode to mitigate the effect of the coupling capacitance between a first sensor electrode of a plurality of sensor electrodes and the at least one display electrode. In various embodiments, the display electrode is at least one of a source electrode that drives a voltage onto a storage element associated with the pixel, a gate electrode that sets a gate voltage on a transistor associated with the pixel, and a common electrode that provides a reference voltage to the storage element.

In one embodiment, the sensor module and display driver module may be comprised within a common integrated circuit (first controller). In another embodiment, the sensor module and display driver module are comprised in two separate integrated circuits. In those embodiments comprising multiple integrated circuits, a synchronization mechanism may be coupled between them, configured to synchronize display updating periods, sensing periods, transmitter signals, display update signals, and the like.

### Oversampled Step and Wait System

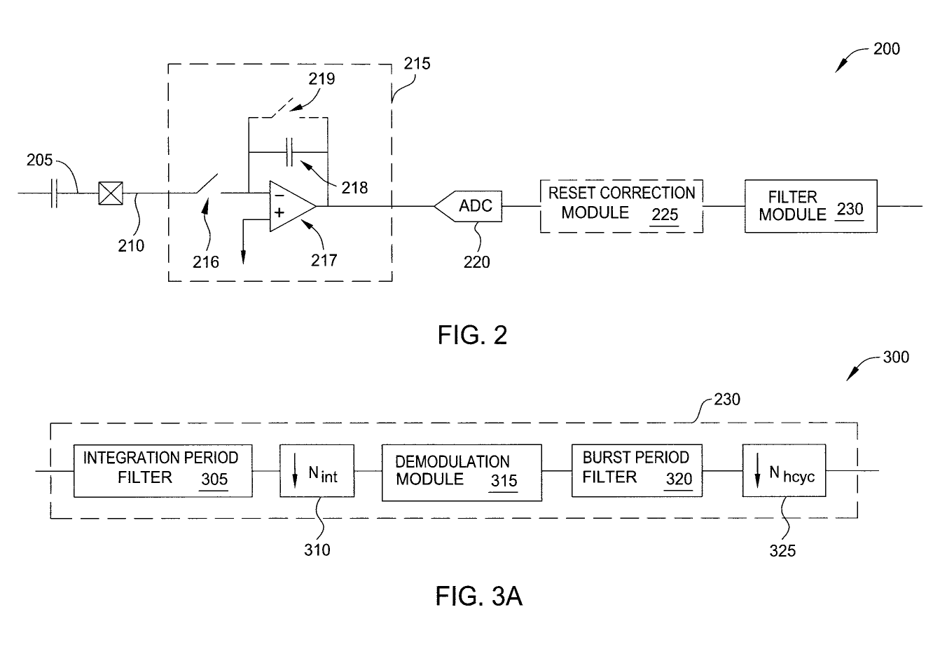

FIG. 2 is a block diagram of an exemplary processing system, according to one embodiment. Arrangement 200 provides one implementation of the processing system 110 included in input device 100.

Arrangement 200 includes a transmitter electrode 205 and receiver electrode 210, each of which are examples of sensor electrodes 120. The transmitter electrode 205 and receiver electrode 210 are capacitively coupled, such that driving a capacitive sensing signal onto the transmitter electrode 205 causes a resulting signal to be received on the receiver electrode 210. In some embodiments (e.g., transcapacitive sensing), the transmitter electrode 205 is a different electrode from the receiver electrode 210. In some embodiments (e.g., absolute capacitive sensing), the transmitter electrode 205 can be the same as the receiver electrode 210. That is, in some embodiments, the capacitive sensing signal may be driven and the resulting signal may be received by the same electrode.

Arrangement 200 includes a charge integration module 215 comprising hardware that generally operates to accumulate charge on the receiver electrode 210 for performing capacitive measurements. The charge integration module 215 includes an input switch 216 that is closed to begin (or resume) accumulating charge, and opened to halt (or pause) the accumulation. The input switch 216 may be a transistor or any other suitable switching device.

Charge integration module 215 includes an operational amplifier (op-amp) 217 that is selectively coupled with the receiver electrode 210 via the input switch 216. Charge integration module 215 includes a feedback capacitor 218 arranged between the output terminal and the negative input terminal of op-amp 217. Some embodiments of charge integration module 215 include a reset switch 219, which is closed to couple the output of the op-amp 217 with a predetermined voltage. As shown, the positive input terminal of op-amp 217 is grounded and causes the voltage of the output terminal to go to ground when reset switch 219 is closed. Other values of the predetermined voltage are possible. For example, the positive input terminal may be connected with a voltage at a midpoint between the rail voltages, such as (Vdd/2).

The output of the charge integration module 215 is coupled with an analog-to-digital converter (ADC) 220 configured to sample values of the output. In some embodiments, the ADC 220 samples multiple times during each sensing half-cycle of the capacitive sensing signal for improved sensing performance, and produces corresponding half-cycle sensing data. In some embodiments, the ADC 220 is configured to sample the output of the charge integration module 215 periodically during an integration period within the sensing half-cycle, and the last sample is aligned to occur at the end of the integration period. In some embodiments, the ADC 220 is further configured to not sample the output of charge integration module 215 during a stretch period occurring during the sensing half-cycle. For embodiments of arrangement 200 including a reset switch 219, the arrangement 200 may further include a reset correction module 225 that is configured to mitigate the interference susceptibility of the input device that is introduced through use of the reset switch 219.

Filter module 230 is configured to receive the half-cycle sensing data that is produced by the ADC 220, which in some cases is also processed by the reset correction module 225. The filter module 230 comprises hardware in some cases, but in some embodiments can be implemented specifically in software, firmware, etc. The filter module 230 generally operates to attenuate interference components of the received signal at one or more frequencies. The filter module 230 includes one or more stages of analog and/or digital filtering. The filtered data is subsequently used to determine positional information for an input object, e.g., using a host processor of the input device and/or a determination module of the processing system. In one alternate embodiment, the filter module 230 includes at least one filter stage prior to the ADC 220, and may include one or more filter stages after the ADC 220. In one example, the charge integration module 215 does not include the reset switch 219 but includes a resistor disposed in parallel with the feedback capacitor 218. The combination of the resistor and feedback capacitor 218 acts as an analog high-pass filter that attenuates low frequency interference in the output provided to ADC 220.

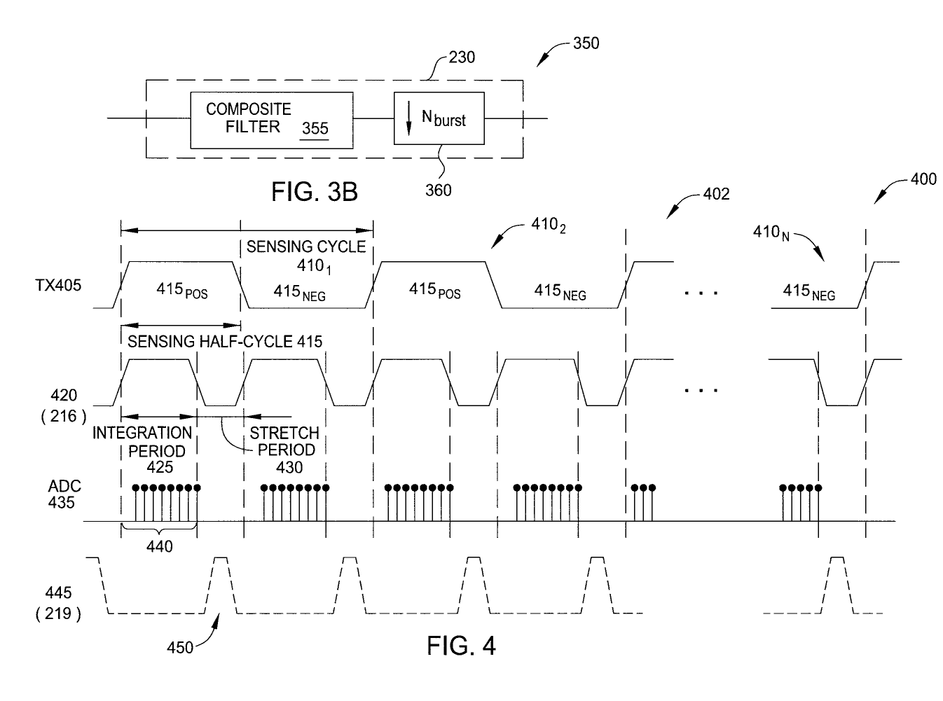

FIGS. 3A and 3B are block diagrams illustrating different implementations of an exemplary filter module, according to one embodiment. Implementation 300 of filter module 230 includes an integration period filter 305, downsampler 310, demodulation module 315, burst period filter 320, and downsampler 325.

In some embodiments, a capacitive measurement corresponds to a “burst” of a plurality of sensing cycles within the transmitted capacitive sensing signal. Each sensing cycle includes two sensing half-cycles of alternating polarity, such that the entire burst corresponds to a predetermined number N_{hcyc} of sensing half-cycles. Within each of the N_{hcyc} sensing half-cycles, and during operation of the charge integration module 215 (FIG. 2), a number of samples Nᵢₙₜ are acquired by the ADC 220. Thus, the total number of samples included in each burst is N_{burst}=N_{hcyc}×Nᵢₙₜ.

The samples are filtered by the integration period filter 305 at the ADC sampling rate. The integration period filter 305 is typically a digital windowing filter configured to produce a weighted average of ADC samples using any suitable windowing function. Some examples of the integration period filter 305 include a rectangular window, a sinusoidal window corresponding to a maximum sensing frequency, a sinusoidal window corresponding to a minimum sensing frequency, a Hanning window, and so forth. The downsampler 310 then downsamples the filtered data by the number of samples Nᵢₙₜ included in each half-cycle.

The demodulation module 315 generally operates to coherently combine the data acquired during the positive and negative sensing half-cycles. The demodulation module 315 comprises hardware in some cases, but in some embodiments can be implemented specifically in software, firmware, etc. In some embodiments, the demodulation module 315 includes a multiplier configured to multiply the downsampled data alternately by 1 or −1 depending on the polarity of the sensing half-cycle, although other types of demodulation are possible depending on the characteristics of the capacitive sensing signal.

The demodulated data is filtered using a burst period filter 320. The burst period filter 320 is typically a second digital windowing filter. The burst period filter 320 generally performs a weighted averaging of the integration period filter 305 output and filters the noise/interference at frequencies between odd harmonics of the sensing frequency. The length and shape of the burst period filter 320 determine a ‘channel selectivity’, that is, the width of a main lobe around the sensing frequency and the amplitude of the nulls at other frequencies. Downsampler 325 then downsamples the data by the number of sensing half-cycles N_{hcyc} corresponding to each burst.

In the implementation 350 of filter module 230 depicted in FIG. 3B, a composite filter 355 is applied to the data samples acquired by the ADC 220. The composite filter 355 may incorporate several functional modules shown in arrangement 300 (e.g., integration period filtering, demodulation, and burst period filtering), and operates at the ADC sampling rate. The downsampler 360 then downsamples the data by the number of samples included in each burst N_{burst}. In some cases, using the composite filter can provide improved filtering performance, as the burst period filter operates at full ADC sample resolution, instead of a reduced resolution associated with previously downsampled data (i.e., after downsampler 310).

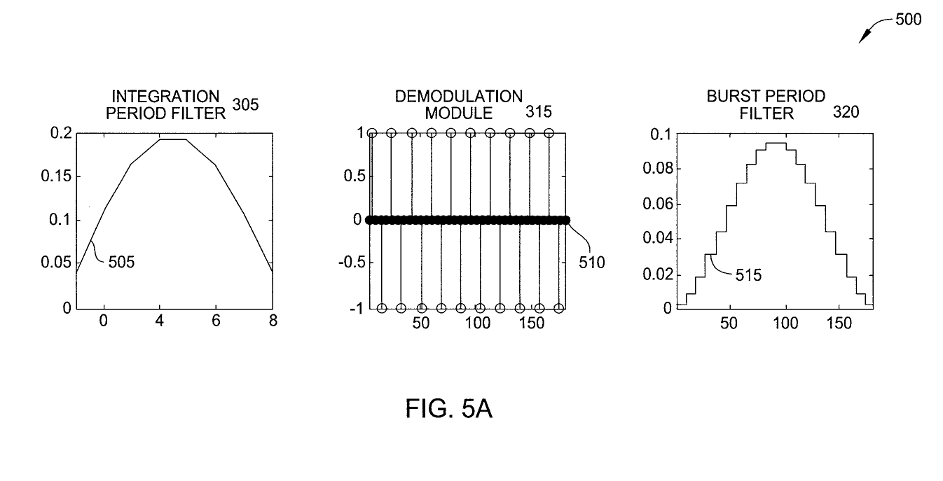

FIG. 4 is a timing diagram illustrating operation of an exemplary processing system, according to one embodiment. Generally, diagram 400 depicts operation of the processing system during an exemplary burst within a capacitive sensing signal.

The transmit (TX) plot 405 represents the capacitive sensing signal transmitted by a transmitter electrode. As shown, the capacitive sensing signal is a square wave having desired characteristics, though other suitable waveforms are possible. The capacitive sensing signal is transmitted as a burst 402 of N sensing cycles 410₁ to 410_{N}. Each sensing cycle 410 includes a positive half-cycle 415_{POS} and negative half-cycle 415_{NEG}.

Plot 420 represents the operation of input switch 216 of the charge integration module. Within each sensing half-cycle 415, plot 420 includes an integration period 425 and a stretch period 430. During the integration period 425, the input switch 216 is closed and the charge integration module accumulates charge from the received capacitive sensing signal. During the stretch period 430, the input switch 216 is opened and the charge integration module pauses or halts the accumulation of charge.

Generally, the sense frequency may be selected and/or adjusted during operation of the processing system in order to avoid sources of interference. In order to change a sense frequency, the length of the integration period 425 and/or the length of the stretch period 430 may be adjusted. In some embodiments, in order to provide a consistent baseline for performing ADC calculations across changes in sense frequency, the length of the integration period 425 is essentially maintained the same while the length of the stretch period 430 is adjusted. Generally, a longer stretch period 430 corresponds to a longer sensing half-cycle 415 and a lower sense frequency, and vice versa. In some embodiments, the stretch period 430 can be up to 20% or more of the corresponding sensing half-cycle. Thus, the length of stretch period 430 may be selected and/or adjusted based on desired sensing frequency.

The operation of ADC 220 is depicted in plot 435. A predetermined number of samples 440 are acquired during the integration period 425 of each sensing half-cycle. Traditionally, an ADC acquires a single sample at the end of each integration period 425 (i.e., one sample per sensing half-cycle). Sampling by the ADC causes aliasing and increases interference susceptibility of the input device at odd harmonics of the sense frequency. In some embodiments, the sampling frequency of the ADC is increased to sample two or more samples per sensing half-cycle, such that the effects of aliasing are shifted to higher frequencies and that the filter module can provide a greater attenuation of the higher frequency content.

Plot 445 illustrates operation of the reset switch 319. The reset switch 319 is open during each integration period 425, allowing the charge integrator module to accumulate charge. Within each stretch period 430, the reset switch 319 can be closed for a period 450 to reset the charge integrator module to a predetermined value. However, the operation of the reset switch 319 causes increased interference susceptibility and can mitigate the reduced susceptibility that is provided by the oversampling and filtering techniques discussed above.

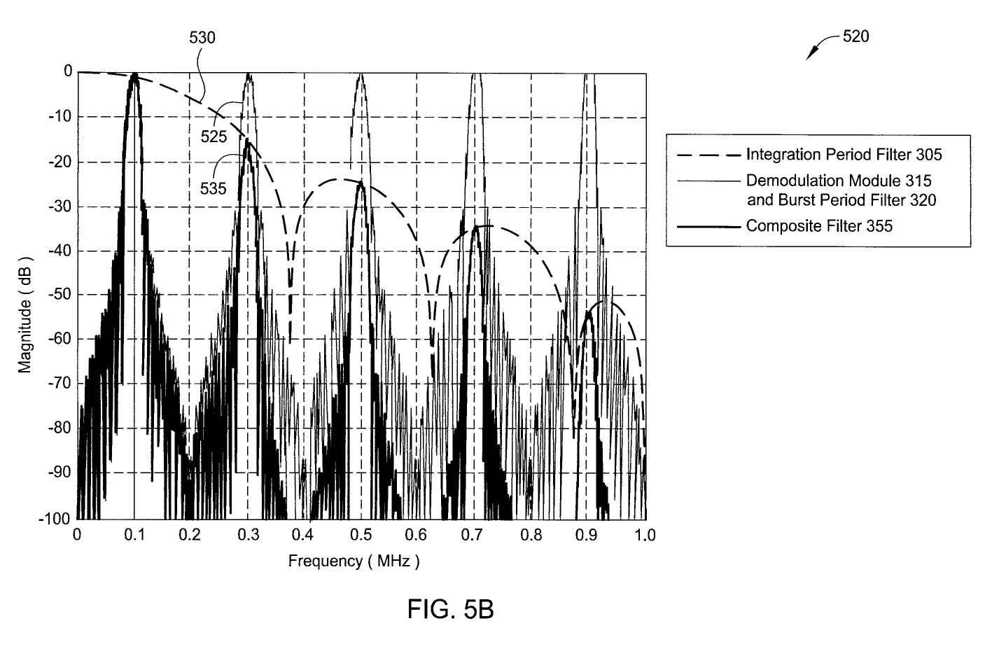

FIG. 5A illustrates impulse responses of components of an exemplary filter module, according to one embodiment. Plot 505 depicts an impulse response of an exemplary integration period filter 305. Generally, the integration period filter is a digital windowing filter that provides a weighted averaging of the ADC samples. For example, the windowing filter may use a rectangular window, sinusoidal window, Hanning window, etc. As shown, the windowing filter operates on eight samples, although this number may vary.

Plot 510 depicts an impulse response of demodulation module 315. As shown, each set of eight ADC samples corresponds alternately to a positive sensing half-cycle and a negative sensing half-cycle. Accordingly, plot 510 depicts multiplying the downsampled ADC samples alternately by 1 and −1 resulting in the same signal polarity at the demodulator output.

Plot 515 shows burst period filter 320, which as discussed above operates on the demodulated data to perform a weighted averaging, and filters the noise/interference at frequencies between odd harmonics of the sensing frequency. The properties of the burst period filter 320 can be selected to control a channel selectivity.

FIG. 5B illustrates frequency response of components of an exemplary filter module, according to one embodiment. Diagram 520 corresponds to a sense frequency of 100 kilohertz (kHz). Plot 525 illustrates the frequency response of the combination of the demodulation module 315 and burst period filter 320 (separate from integration period filtering). This combination of components is susceptible to interference at the sense frequency (i.e., a fundamental frequency) and at odd harmonics of the sense frequency (i.e., at 300, 500, 700, and 900 kHz).

Plot 530 illustrates the attenuation provided by the integration period filter 305. Plot 535 shows the susceptibility of composite filter 355 (or alternately, the composite effect of the filter module 230). Generally, plot 535 reflects the susceptibility of the combination of demodulation module 315 and burst period filter 320 (plot 525) after being attenuated by the integration period filter 305 (plot 535). Plot 535 illustrates a reduced susceptibility at the odd harmonics of the sense frequency. Beyond the use of integration period filter 305 or composite filter 355 within a filter module, increasing the sampling frequency of the ADC may further reduce the susceptibility of the input device to interference.

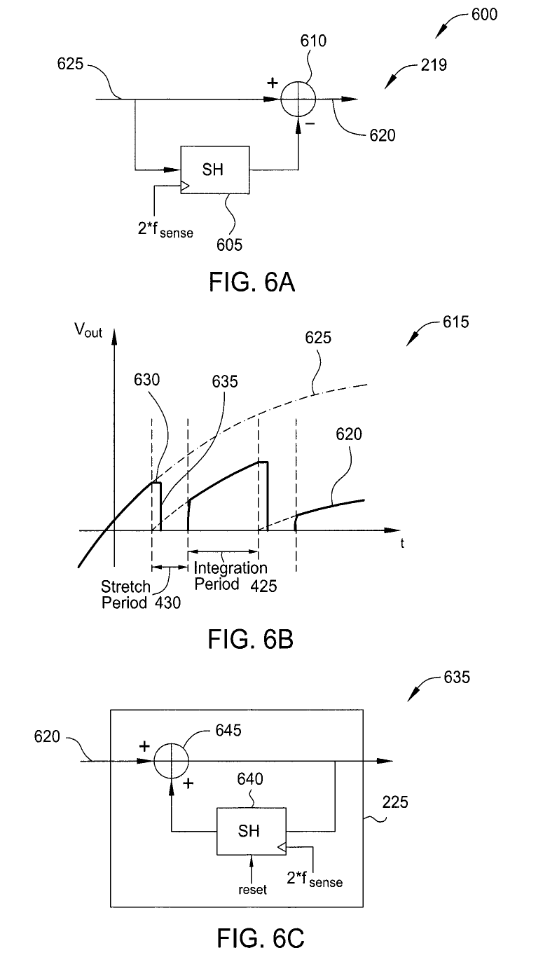

FIGS. 6A and 6B illustrate effects of a reset switch within a charge integration module, according to one embodiment.

Graph 615 includes output signal 620 of a charge integration module using a reset switch to periodically reset the output to a predetermined level. Graph 615 also includes plot 625, which represents an output signal of a charge integration module without using a periodic reset and without pausing charge accumulation, e.g., during a stretch period.

During a stretch period 430 of a sensing half-cycle, the input switch of the charge integration module is open, so that the charge integration module does not continue to accumulate charge. Thus, upon opening the input switch at a transition between the integration and stretch periods, the value of the output signal 620 is held for a period 630. When a reset event 635 occurs within the stretch period 430, the reset switch is closed and the output signal 620 is reset to a predetermined value. As shown, the predetermined value corresponds to a zero voltage, but may be any other suitable value. At a time during the stretch period, and following the output signal reaching the predetermined value, the reset switch is again opened. However, the output signal remains at the predetermined value until the next integration period 425 begins. In contrast, plot 625 shows a substantially continuous accumulation of charge reflected in an increasing output voltage value.

Arrangement 600 is a block diagram illustrating the digital logic equivalent of the reset operation, which may be carried out using analog circuitry. The input signal (plot 625) is sampled by a sample and hold (SH) circuit 605. Because the sample and hold circuit 605 samples during both the positive sensing half-cycle and the negative sensing half-cycle, the circuit operates at a frequency of twice the sense frequency fₛₑₙₛₑ. The samples are held and subtracted from the input signal at subtractor 610 to produce the output signal 620 of the charge integration module.

The sampling operation of the sample and hold circuit 605 leads to aliasing and non-attenuated susceptibility at odd harmonics. In fact, the benefit of reduced susceptibility from increasing the sampling frequency of the ADC and filtering the samples is reduced or negated by the susceptibility introduced by using the periodic reset.

FIG. 6C illustrates an exemplary reset correction module, according to one embodiment. The arrangement 635 provides one possible configuration of the reset correction module 225. The effects of operating the reset switch of the charge integration module can be substantially mitigated by the reset correction module 225. In some embodiments, the reset correction module 225 includes a sample and hold circuit 640 that samples the output signal 620 when the input switch of the charge integration module closes (e.g., on a transition between the stretch and integration periods). The sample and hold (SH) circuit 640 samples at two times the sense frequency fₛₑₙₛₑ. The adder 645 adds the sample to the current value of output signal 620 to reconstruct the original output waveform from the charge integration module, which removes the interference-producing portions of output signal 620 caused by operation of the reset switch.

In some embodiments, the reset correction module 225 may be further configured to reset the sample and hold value of the sample and hold circuit 640 at the end of each burst of sensing half-cycles, effectively allowing a reset between bursts. This configuration does not affect interference susceptibility of the input device, as downsampling occurs at the end of the burst. As seen in the modeling of FIG. 6A, a reset operation has similar effects as sampling (note the sample and hold circuit 605). By allowing a reset to occur at the end of the burst (i.e., where the final downsampling happens) the aliasing caused by sampling again (using sample and hold circuit 640) will still occur. However, at this stage the filtering has been completed such that the interference has already been attenuated (see plot 535 of FIG. 5B) so any amount of aliased interference energy is much less than if the reset correction was performed before the filtering stage(s).

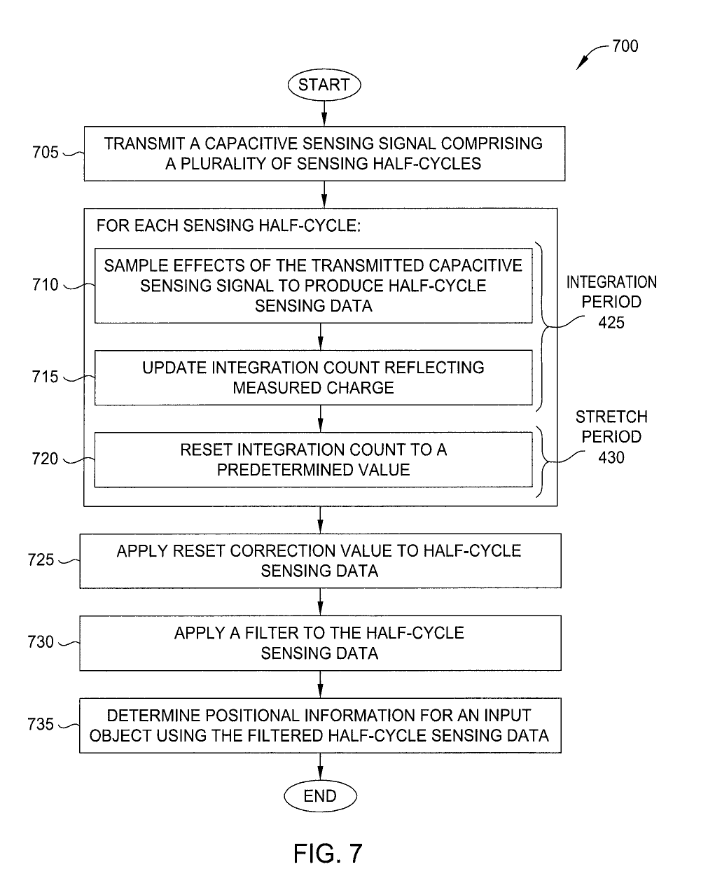

FIG. 7 illustrates a method of capacitive sensing, according to one embodiment. Method 700 is generally performed using a processing system of an input device. Method 700 begins at block 705, where the processing system transmits a capacitive sensing signal comprising a plurality of sensing half-cycles. In some embodiments, the plurality of sensing half-cycles includes alternating positive and negative half-cycles.

Method 700 enters a loop for each sensing half-cycle of the transmitted capacitive sensing signal. Each sensing half-cycle may include a respective integration period 425 and stretch period 430. Within the integration period 425, at block 710 the processing system samples effects of the transmitted capacitive sensing signal to produce half-cycle sensing data. In some embodiments, an ADC performs a plurality of samples during each sensing half-cycle in order to improve sensing performance, reducing susceptibility at lower sense frequencies. At block 715 and during the integration period, the processing system updates an integration count reflecting measured charge from the sampled effects.

At block 720 and during the stretch period, the processing system resets the integration count to a predetermined value. In some embodiments, the processing system performs the reset by closing a reset switch in the charge integration module. At block 725, the processing system applies a reset correction value to the half-cycle sensing data. In some embodiments, the reset correction value mitigates interference susceptibility of the input device that is introduced by operation of the reset switch.

At block 730, the processing system applies a filter to the half-cycle sensing data. The filter includes one or more filtering stages of analog and/or digital filtering. For example, the filter may include digital windowing filter(s) and/or a demodulation module and/or downsampler(s). In one embodiment, the filter includes a composite filter that performs several separate filtering and/or demodulation functions at a same rate. At block 735, the processing system determines positional information for an input object using the filtered half-cycle sensing data. Method 700 ends following completion of step 735.

### CONCLUSION

Oversampling the effects of the transmitted capacitive sensing signal received during sensing half-cycles and performing appropriate analog and/or digital filtering can improve immunity of an input device to interference. For embodiments of the input device including a reset functionality within the charge integration module, the reset functionality can operate to reduce or negate the increased immunity of the input device that results from the oversampling and filtering techniques. In some embodiments, a reset correction module can mitigate the frequency susceptibility introduced by the reset functionality.

Thus, the embodiments and examples set forth herein were presented in order to best explain the embodiments in accordance with the present technology and its particular application and to thereby enable those skilled in the art to make and use the disclosure. However, those skilled in the art will recognize that the foregoing description and examples have been presented for the purposes of illustration and example only. The description as set forth is not intended to be exhaustive or to limit the disclosure to the precise form disclosed.

In view of the foregoing, the scope of the present disclosure is determined by the claims that follow.

We claim:

1. A method of capacitive sensing using an input device comprising a plurality of transmitter electrodes and a plurality of receiver electrodes, the method comprising:
transmitting, on one or more of the plurality of transmitter electrodes, a capacitive sensing signal comprising a plurality of sensing half-cycles;
sampling, two or more times during each sensing half-cycle, effects of the transmitted capacitive sensing signal on one or more of the plurality of receiver electrodes to produce half-cycle sensing data;
filtering the half-cycle sensing data; and
determining positional information for an input object using the filtered half-cycle sensing data.

2. The method of claim 1, wherein filtering the half-cycle sensing data comprises a weighted averaging of the sampled effects of the half-cycle sensing data.

3. The method of claim 1, wherein each of the plurality of sensing half-cycles comprises a respective integration period and a respective stretch period, wherein sampling the effects of the transmitted capacitive sensing signal is performed during each integration period.

4. The method of claim 3, wherein the capacitive sensing signal is transmitted in at least first and second bursts, wherein each burst includes a respective plurality of sensing half-cycles, wherein the sensing half-cycles of the first burst have a stretch period of a first length, and wherein the sensing half-cycles of the second burst have a stretch period of a second length different from the first length.

5. The method of claim 3, further comprising:
updating, during each integration period, an integration count reflecting charge that is measured during the integration period, wherein the sampled effects correspond to the integration count;
resetting, during each stretch period, the integration count to a predetermined value; and
applying a reset correction value to the half-cycle sensing data prior to filtering the half-cycle sensing data.

6. The method of claim 1, comprising performing absolute capacitive sensing techniques to obtain the sampled effects of the transmitted capacitive sensing signal.

7. The method of claim 1, comprising performing transcapacitive sensing techniques to obtain the sampled effects of the transmitted capacitive sensing signal.

8. The method of claim 1, wherein the filter applied to the half-cycle sensing data is a digital windowing filter.

9. An input device, comprising:
a plurality of transmitter electrodes;
a plurality of receiver electrodes; and
a processing system coupled with the plurality of transmitter electrodes and the plurality of receiver electrodes, and comprising circuitry configured to:
transmit, on one or more of the plurality of transmitter electrodes, a capacitive sensing signal comprising a plurality of sensing half-cycles;
sample, two or more times during each sensing half-cycle, effects of the transmitted capacitive sensing signal on one or more of the plurality of receiver electrodes to produce half-cycle sensing data;
filtering the half-cycle sensing data; and
determine positional information for an input object using the filtered half-cycle sensing data.

10. The input device of claim 9, wherein filtering the half-cycle sensing data comprises a weighted averaging of the sampled effects of the half-cycle sensing data.

11. The input device of claim 9, wherein the processing system is configured to:
transmit the capacitive sensing signal with each of the plurality of sensing half-cycles comprising a respective integration period and a respective stretch period, and
sample the effects of the transmitted capacitive sensing signal during each integration period.

12. The input device of claim 11, wherein the capacitive sensing signal is transmitted in at least first and second bursts, wherein each burst includes a respective plurality of sensing half-cycles, wherein the sensing half-cycles of the first burst have a stretch period of a first length, and wherein the sensing half-cycles of the second burst have a stretch period of a second length different from the first length.

13. The input device of claim 11, wherein the processing system comprises a charge integrator having a reset switch, and wherein the processing system is further configured to:
update, using the charge integrator and during each integration period, an integration count reflecting charge that is measured during the integration period, wherein the sampled effects correspond to the integration count;
close, during each stretch period, the reset switch to reset the integration count to a predetermined value; and
apply a reset correction value to the half-cycle sensing data prior to filtering the half-cycle sensing data.

14. The input device of claim 9, wherein the processing system is configured to perform absolute capacitive sensing techniques to obtain the sampled effects of the transmitted capacitive sensing signal.

15. The input device of claim 9, wherein the processing system is configured to perform transcapacitive sensing techniques to obtain the sampled effects of the transmitted capacitive sensing signal.

16. The input device of claim 9, wherein the processing system comprises a digital windowing filter configured to filter the half-cycle sensing data.

17. A processing system for capacitive sensing, comprising:
touch controller circuitry configured to:
couple with a plurality of transmitter electrodes and a plurality of receiver electrodes;
transmit, on one or more of the plurality of transmitter electrodes, a capacitive sensing signal comprising a plurality of sensing half-cycles;
sample, two or more times during each sensing half-cycle, effects of the transmitted capacitive sensing signal on one or more of the plurality of receiver electrodes to produce half-cycle sensing data;
filtering the half-cycle sensing data; and
determine positional information for an input object using the filtered half-cycle sensing data.

18. The processing system of claim 17, wherein the touch controller circuitry is configured to:
transmit the capacitive sensing signal with each of the plurality of sensing half-cycles comprising a respective integration period and a respective stretch period, and
sample the effects of the transmitted capacitive sensing signal during each integration period.

19. The processing system of claim 18, wherein the touch controller circuitry further comprises a charge integrator having a reset switch, and wherein the touch controller circuitry is further configured to:
update, using the charge integrator and during each integration period, an integration count reflecting charge that is measured during the integration period, wherein the sampled effects correspond to the integration count;
close, during each stretch period, the reset switch to reset the integration count to a predetermined value; and
apply a reset correction value to the half-cycle sensing data prior to filtering the half-cycle sensing data.

20. The processing system of claim 17, wherein the touch controller circuitry further comprises a digital windowing filter configured to filter the half-cycle sensing data.
